(19) United States
(12) Patent Application Publication
(10) Pub. No.: US 2009/0158273 A1
(43) Pub. Date: Jun. 18, 2009

(54) Systems and methods to distribute software for client receivers of a content distribution system

(76) Inventors: Thanabalan Thavittupitchai Paul, Carmel, IN (US); Gary Robert Gutknecht, Noblesville, IN (US); Barry Weber, Carmel, IN (US)

Correspondence Address: Thomson Licensing LLC, P.O. Box 5312, Two Independence Way, PRINCETON, NJ, 08543-5312, US

(21) Appl. No.: 12/002,716

(22) Filed: Dec. 18, 2007

(51) Int. Cl. G06F 9/445; H04L 9/00

(52) U.S. Cl. 717/178; 713/163

(57) ABSTRACT

A content distribution system employs IP multicast techniques to facilitate in identifying software dynamically, and to facilitate in downloading the software from the appropriate server to diverse client receivers. The clients monitor multicasts from a server and utilize a master/slave hierarchy technique to assist in requesting desired software blocks. The server sends out multicasts with payloads that identity, for example, manufacturers and model numbers of client receivers. The client receivers can then listen and download the payloads that pertain to their specific models. The master/slave technique allows only a master client receiver to request software blocks. Once fulfilled, the master status can be passed to another client receiver to request software blocks.

### TECHNICAL FIELD

The subject-matter relates-generally to-content-distribution,-and-more particularly to systems and methods for automatically selecting and downloading software for content distribution system client receivers on a network.

### BACKGROUND

Content distribution systems for televisions and other types of video/audio systems have evolved into complex systems that interact through networks. These types of systems can even use the Internet and telephone systems to distribute content. For example, a television content distribution system for multiple dwelling units can utilize Internet Protocol (IP) for the delivery of television content and services. These systems can be comprised of one or more gateway server devices that interact with different types of settop box (STB)-client receivers. Thus, there can be hundreds of receivers of different types and models that need to be updated and/or maintained on a regular basis. For example, operational software may need to be downloaded from a server to various receiver clients to keep the clients up-to-date. This leads to several problems. Namely, to figure out what models need the software from the server device and to identify what STB models/versions are supported by the server device. If the correct version is determined, then a process must figure out how to connect the server and client so that the software can be downloaded. Often this is time critical. For example, if a power failure occurs, it is likely that most STB-client receivers will attempt to come-up at the same time and all attempt to download software at once. Thus, the process needs to be quick in order to handle this type of en mass downloading.

### SUMMARY

IP multicast techniques are leveraged to facilitate in identifying software and to facilitate in downloading the software from a server to a client of a content distribution system. The clients monitor multicasts from a server and utilize a master/slave hierarchy technique to assist in requesting desired software blocks. The server sends out multicasts with payloads that identify, for example, manufacturers and model numbers of client receivers for whom the server has the software for. The client receivers can then listen and download the payloads that pertain to their specific models, dynamically connecting to the appropriate server, as necessary. The master/slave technique allows only a master client receiver to request software blocks. Once fulfilled, the master status can be passed to another client receiver to request software blocks. The client receivers determine which software blocks are needed based on the multicast information (e.g., manufacturer, model number, software version, etc.) from the servers and on the basis of prior software-blocks downloaded. This allows a diverse grouping of client receivers to quickly download needed software in an orderly manner.

The above presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

To the accomplishment of the foregoing and related ends, certain illustrative aspects of embodiments are described herein in connection with the following description and the annexed drawings. These aspects are indicative, however, of but a few of the various ways in which the principles of the subject matter can be employed, and the subject matter is intended to include all such aspects and their equivalents. Other advantages and novel features of the subject matter can become apparent from the following detailed description when considered in conjunction with the drawings.

### BRIEF DESCRIPTION OF THE DRAWINGS

FIG. 1 is a block diagram of a software distribution system in accordance with an aspect of an embodiment.

FIG. 2 is another block diagram of a software distribution system in accordance with an aspect of an embodiment.

FIG. 3 is an example of a software distribution system with multiple clients in accordance with an aspect of an embodiment.

FIG. 4 is an example of message traffic between a server and client in accordance with an aspect of an embodiment.

FIG. 5 is a flow diagram of a method of receiving software via multicast messages in accordance with an aspect of an embodiment.

FIG. 6 is another flow diagram of a method of receiving software via multicast messages in accordance with an aspect of an embodiment.

FIG. 7 is yet another flow diagram of a method of receiving software via multicast messages in accordance with an aspect of an embodiment.

FIG. 8 is a flow diagram of a method of assigning a hierarchy for requesting software in accordance with an aspect of an embodiment.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It can be evident, however, that subject matter embodiments can be practiced without these specific details. In other instances, well-known structures and devices are shown in block diagram form in order to facilitate describing the embodiments.

As used in this application, the term “component” is intended to refer to hardware, software, or a combination of hardware and software in execution. For example, a component can be, but is not limited to being, a process running on a processor, a processor, an object, an executable, and/or a microchip and the like. By way of illustration, both an application running on a processor and the processor can be a component. One or more components can reside within a process and a component can be localized on one system and/or distributed between two or more systems. Functions of the various components shown in the figures can be provided through the use of dedicated hardware as well as hardware capable of executing software in association with appropriate software.

When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting instances and embodiments of the invention are intended to encompass both structural and functional equivalents. Additionally, it is intended that such equivalents include both currently known equivalents as well as equivalents developed in the future (i.e., any elements developed that perform the same function, regardless of structure).

The systems and methods disclosed herein allow clients such as, for example, settop box receivers to efficiently recognize and/or request operational software it needs from a gateway server device. This is accomplished automatically via self-identification which then permits efficient downloading of software and boot-up of the receiver. Multicast messaging is used as a delivery mechanism to at least one receiver which, in turn, determines whether software information located in the multicast message has value to that particular receiver. If the software is valuable to that receiver, it can download the software found in the multicast message. This allows the same message to be sent to a multitude of receivers without the server attempting to distinguish between receiver types (e.g., different manufacturers, models, software versions, etc.).

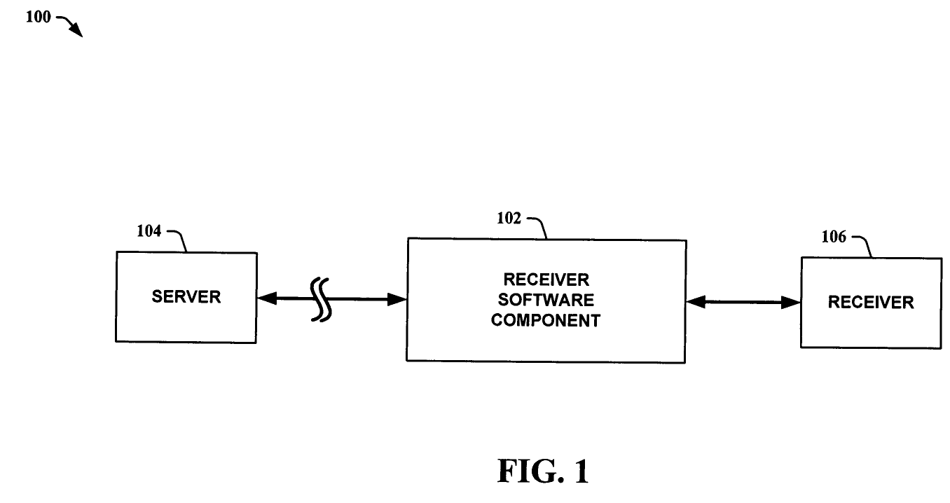

FIG. 1 shows a block diagram of a software distribution system 100 that utilizes a receiver software component 102 to obtain software from a server 104 to download into receiver 106. The receiver software component 102 can reside internally and/or externally to the receiver 106. In the software distribution system 100 the server 104 provides software for any number of clients such as, for example, the receiver 106. The server 104 acts as a gateway server and interacts with various clients via a network such as, for example, the Internet, an intranet, and/or other type of network. The server 104 packages various software blocks along with relevant recipient information such as, for example, manufacturer, model, and/or software version number and the like into multicast messages. The server 104 then sends the messages over the network to any number of clients such as, for example, receiver software component 102 that can reside in receiver 106. The server 104 can be unaware of what specific brands and models of receivers it is distributing the multicast messages to.

The receiver software component 102 listens to the multicast messages and determines whether or not the multicast message contains information pertinent to its associated receiver 106. For example, if the multicast message contains a different manufacturer than the receiver 106, the receiver software component 102 can ignore the message. However, if the manufacturer and model match the receiver 106, the receiver software component 102 can check what software version is contained in the multicast message and download it if it is needed. Thus, the receiver software component 102 automatically ‘self-identifies’ and downloads software if it passes certain requirements. This alleviates the server 104 from having to have knowledge of exactly what clients (e.g., manufacturers, models, software versions, etc.) are on a given network. The software can be quickly distributed via the multicast messages and those clients that need the software listen and download it as required. The receiver software component 102 can also establish a hierarchy of master/slaves between clients and only allow additional software requests by a master client. Once a master client (e.g., receiver/receiver software component) has downloaded its software, it can let the server pass the master client status to another client that still requires software not yet distributed via the multicast messages. The server 104 can accept requests from the receiver software component 102 and provide specifically requested software to be multicast to the clients.

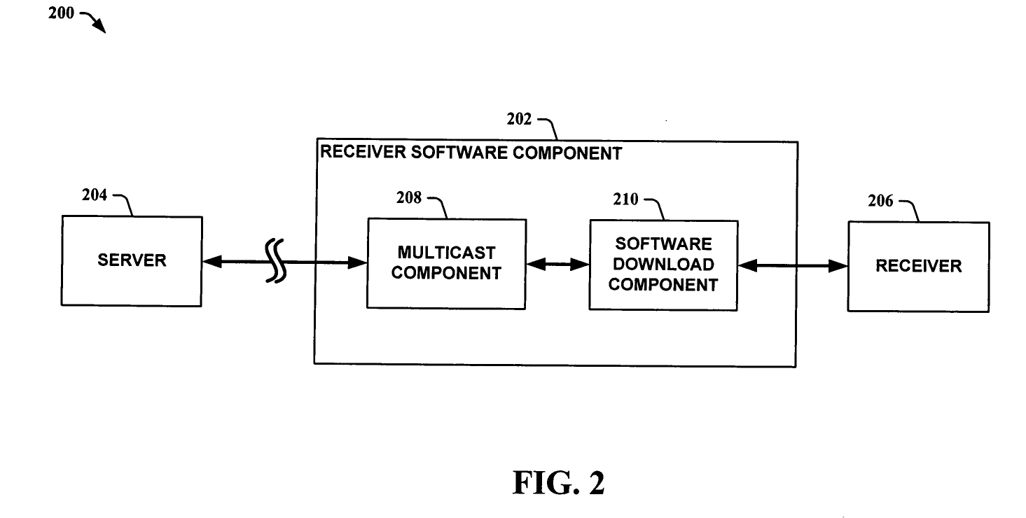

In FIG. 2, a software distribution system 200 employs a receiver software component 202 to obtain software from server 204 for receiver 206. The receiver software component 202 utilizes a multicast component 208 and a software download component 210 to facilitate in accomplishing software changes. The multicast component 208 intercepts or ‘listens in’ on multicast messages sent by the server 204. The server 204 acts as a gateway for software distribution. The multicast component 208 can be augmented to listen for various types of multicast messages such as, for example, session announcement protocol (SAP) announcements and the like. The multicast component 208 can be set up for interpreting various protocols and/or message structures depending on what type of network and/or protocols are used by the software distribution system 200. The multicast component 208 can also accept remote commands from the server 204 to switch to various protocols dynamically.

The multicast component 208 can read the multicast messages sent by the server 204 and pass its message contents to the software download component 210. The message contents can include parameter and/or payload information such as time, date, software version, manufacturer, model, and/or software blocks and the like. The software download component 210 assesses the information received from the multicast component 208 to determine if software contained in the multicast message is relevant to the receiver 206. For example, in some instances, the software download component 210 can check not only manufacturer and model but also determine whether the software version is older or newer than that currently loaded on the receiver 206. Depending on the situation, the software download component. 210 can allow only software upgrades (i.e., newer versions), only software downgrades (i.e., older versions), and/or allow both upgrades and downgrades but not overwrite identical software already loaded into the receiver 206 and the like. Parameters employed by the software download component 210 to determine what is relevant to the receiver 206 can be controlled locally (e.g., user input, factory settings, etc.) and/or remotely (e.g., commands sent from the server 204, etc.).

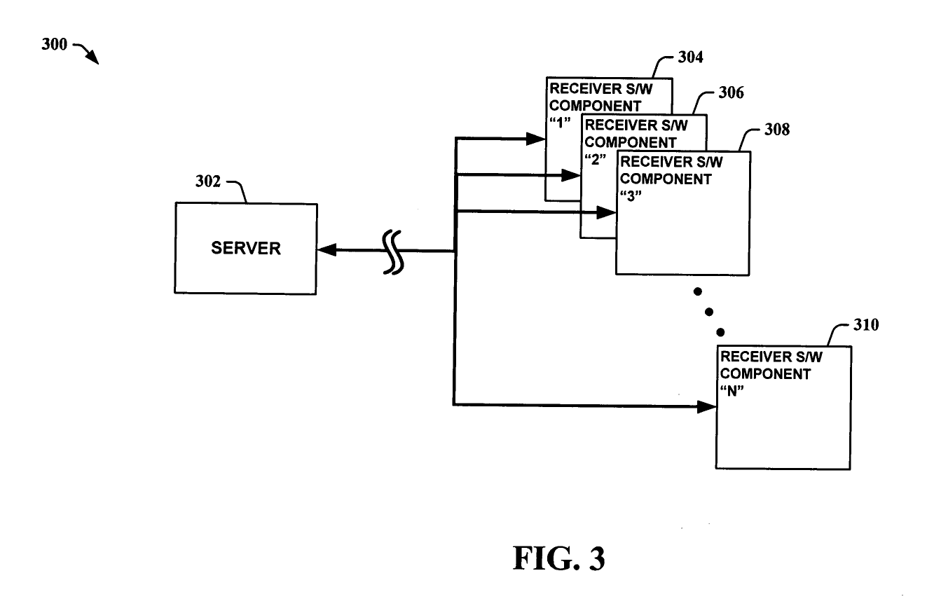

Looking at FIG. 3, an example of a software distribution system 300 with multiple clients “1-N” 304-310 in accordance with an aspect of an embodiment is shown. The example 300 is for illustrative purposes only and is not meant to limit instances disclosed herein in any manner. The software distribution system 300 utilizes the server 302 as a gateway for distributing software via multicast messages to the multiple clients “1-N” 304-310. The example shows that the sever 302 can send a single multicast message to any number of clients such as receiver software components “1-N” 304-310 that can reside in content/service distribution receivers. For example, receiver software component “1” 304 can be a master client. The server 302 sends the multicast messages to all receiver software components “1-N” 304-310 but only responds to specific software requests from the master client, receiver software component “1” 304. For example, if the receiver software component “1” 304 has fulfilled its software needs, the server 302 can pass the master status to, for example, receiver software component “2” 306 and the like. Master status changes can continue until the clients have been multicasted their appropriate software. In some cases, master status changes are not necessary as the multicast messages are sufficient to distribute required software without needing requests from the clients.

Typical content/service distribution systems are comprised of gateway server devices and several different types of STB-client receivers. There can be hundreds of receivers of different types and models that need to be able to download, for example, their operational software from the server device. Some models can self-start the software from flash, whereas many need to download their operational code (to RAM) every time they boot (power-up) which requires a means by which the STBs can easily identify themselves to the server device and request the appropriate software. In case of an unfortunate event such as a power-interruption, it is likely that many STB-client receivers will come-up at the same time trying to download the same software. Instances disclosed herein resolve these issues by allowing the receivers to automatically self-identify and determine which software is appropriate in the server's multicasted messages. By utilizing these instances, for example, IP STB receivers can download the software efficiently, using static and/or dynamic IP addresses. The dynamic model-identification and download-server identification substantially increases overall efficiency and is friendly to the operators involved in the equipment provisioning.

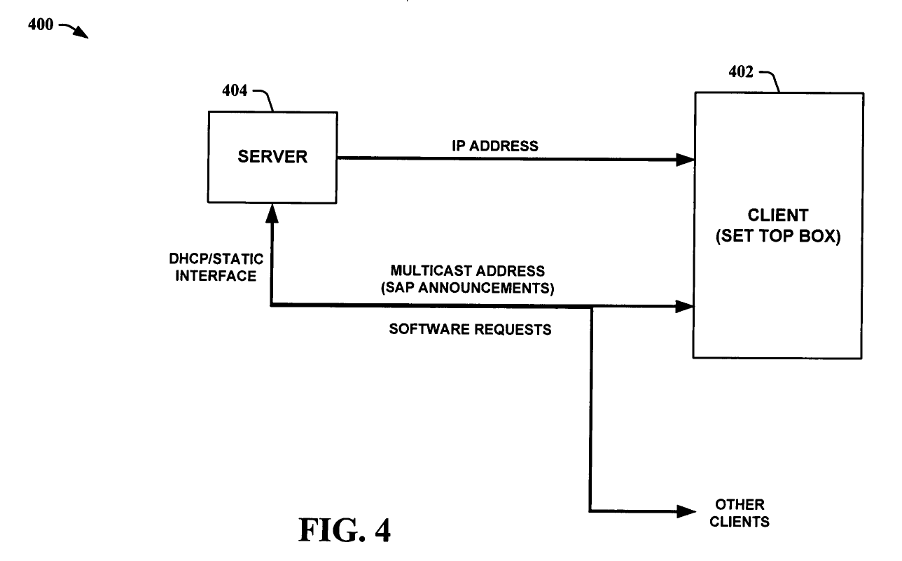

The following is meant to be an example and is not meant to limit instances disclosed herein to specific restrictions on protocol, interfaces, and/or payload/message structure, etc. FIG. 4 depicts an example 400 of interactions between a server 404 and client 402 for the following discussion. In one instance, client-STB's service reception interfaces can be provisioned via DHCP (or static). For example, the STBs can populate option 60, and/or vendor class identifier, and the like in outbound DHCP messages. The vendor class identifier length can be set to, for example, a length of four, and the vendor class identifier payload can contain an identifier such as, for example, “mfh3,” so that a server device can identify the clients. After getting an IP address, the STB-clients can listen to multicast messages such as, for example, SAP announcements coming from the server devices. The payload definition of these announcements can include, for example, the model ID, manufacturer ID, image version, file size, and/or address of the download-server and the like, for the STB models supported by the server devices.

The typical multicast address used by the SAP announcements is 239.255.255.255, port 9875, which is per RFC 2364/IANA. The STB receiver can keep comparing its model/manufacturer ID with the one that is announced, for a specific duration. For example, if a match is found and the advertised image size is greater than zero, and the advertised version number is not equal to a pre-determined value, then the receiver can generate and/or request the filename in the format of, for example, “midMM_XXXX.bin” from a download-server, where MM can be, for example, a two digit manufacturer ID and XXXX can be, for example, a four digit model ID of the receiver. If a match is not found, the STB can still request the image from a server-device, in which case the request can be routed to another head-end device, via the first server-device. For example, the Trivial File Transfer Protocol. (TFTP) can be used by the STB receivers to download its operational software image. The TFTP multicast option can be utilized, for example, to provision for large scale, simultaneous downloads (such as after a building power outage). Additionally, the TFTP block size option can be utilized to reduce the amount of TFTP ACKing that must occur to complete the transfer successfully. The connection can be made dynamic, since the STB-clients can get the download-server device address via the SAP announcements in the previous stage. A subsequent decision to flash the downloaded code and/or to run directly from RAM can depend on the model ID of the STB. In other instances, the server that provides the SAP information can differ from the server that provides the appropriate download. The techniques disclosed herein do not restrict instances to utilizing a single server for all functionality and/or download services.

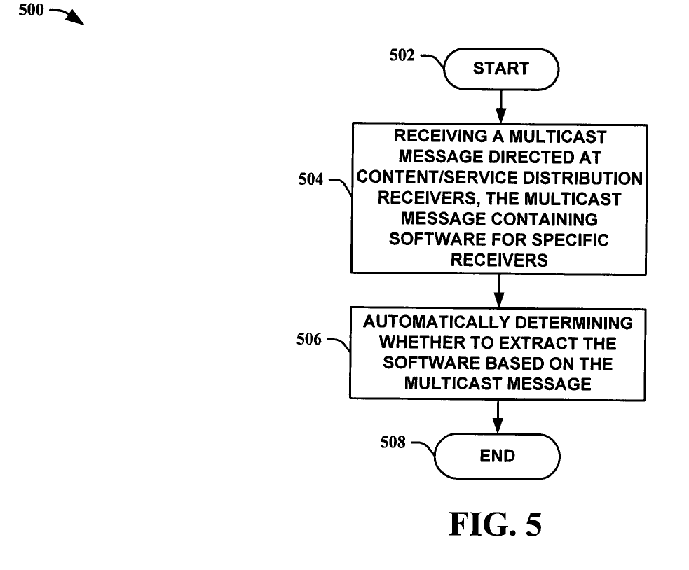

In view of the exemplary systems shown and described above, methodologies that can be implemented in accordance with the embodiments will be better appreciated with reference to the flow charts of FIGS. 5-8. While, for purposes of simplicity of explanation, the methodologies are shown and described as a series of blocks, it is to be understood and appreciated that the embodiments are not limited by the order of the blocks, as some blocks can, in accordance with an embodiment, occur in different orders and/or concurrently with other blocks from that shown and described herein. Moreover, not all illustrated blocks may be required to implement the methodologies in accordance with the embodiments.

In FIG. 5, a flow diagram of a method 500 of receiving software via multicast messages in accordance with an aspect of an embodiment is shown. The method starts 502 by receiving a multicast message directed at content/service distribution receivers, the multicast message containing software for specific receivers 504. In one instance, the content/service distribution receivers can be settop boxes that are interconnected with a server to obtain software changes. The interconnection can include, but is not limited to, the Internet and/or an intranet and the like. Many receivers can utilize cable transmissions, satellite transmissions, telephonic transmissions (e.g., DSL, etc.), Ethernet, and other network type connections to establish connections with the server using various protocols. It is then automatically determined whether to extract the software based on the multicast message 506, ending the flow 508. The receiver can listen in on multicast messages and evaluate the messages to determine when to extract software contained in the messages. Various criteria as described previously can be used to determine if the software should be extracted for that particular receiver.

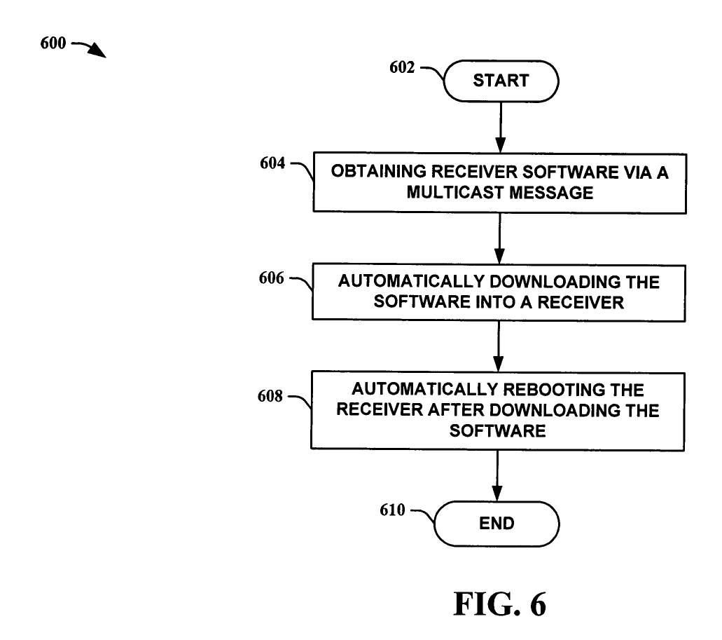

In FIG. 6, a flow diagram of another method 600 of receiving software via multicast messages in accordance with an aspect of an embodiment is depicted. The method starts 602 by obtaining receiver software via a multicast message 604. Once a receiver has determined that the multicast message contains software that meets its requirements, it is extracted from the multicast message. The software is then automatically downloaded into a receiver 606. The extracted software can be downloaded into temporary and/or permanent memory depending on the type of receiver. The receiver is then automatically rebooted after the software is downloaded 608, ending the flow 610. The rebooting is not required. If the receiver can continue to operate and/or can do a warm reboot (without power cycle), it is not necessary to completely reboot the receiver.

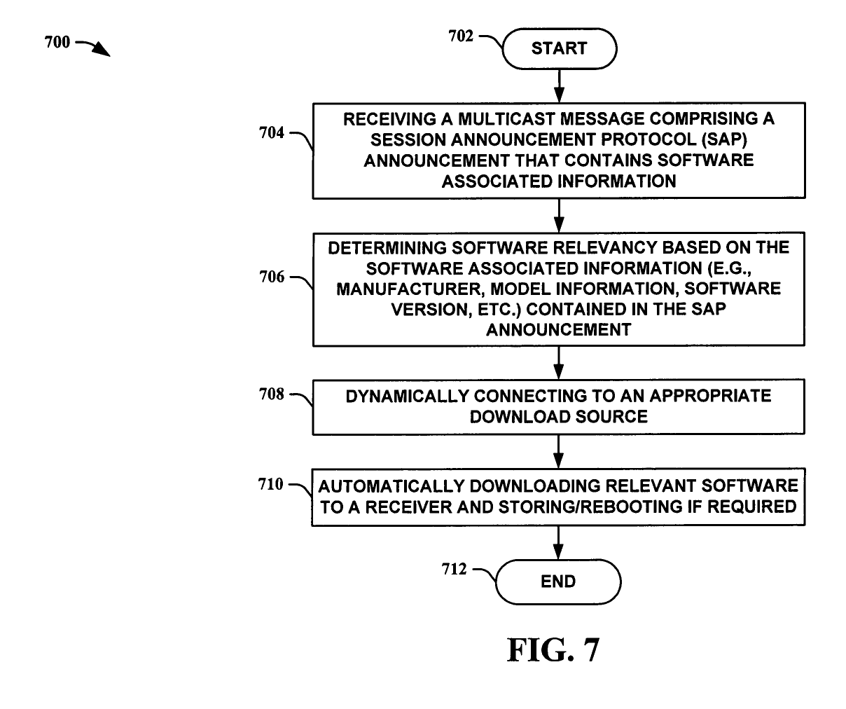

In FIG. 7, a flow diagram of yet another method 700 of receiving software via multicast messages in accordance with an aspect of an embodiment is illustrated. The method starts 702 by receiving a multicast message comprising a session announcement protocol (SAP) announcement that contains software associated information 704. By utilizing the SAP announcement, existing protocols/messages can be employed without requiring the introduction of new interfaces and extensive network changes to implement the instances disclosed herein. Software relevancy is then determined based on the software associated information (e.g., manufacturer ID, model ID, software image version, file size, and/or address of the download-server, etc.) contained in the SAP announcement 706. A dynamic connection is then made to an appropriate download source to provide software access. Relevant software is then automatically downloaded to a receiver and stored and/or the receiver is rebooted if required 710, ending the flow 712. The software can be downloaded to temporary and/or permanent memory. Some receivers do not require rebooting after software downloading. It should be noted that n other instances, the source (e.g., server) that provides the SAP announcement can differ from the source that provides the appropriate download. The techniques disclosed herein do not restrict instances to utilizing a single source (e.g., server) for all functionality and/or download services.

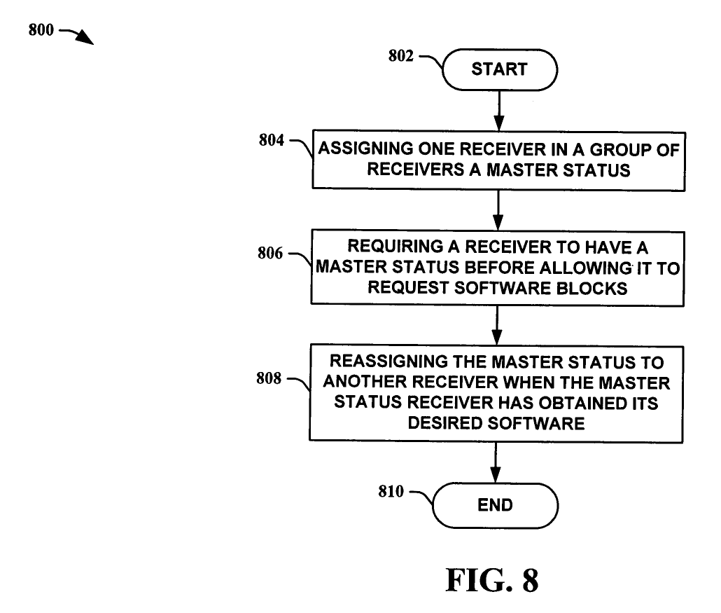

In FIG. 8, a flow diagram of a method 800 of assigning a hierarchy for requesting software in accordance with an aspect of an embodiment is shown. The method starts 802 by assigning one receiver in a group of receivers a master status 804. A receiver is then required to have a master status before it is allowed to request software blocks 806. This is only one example of a hierarchy technique that can be employed by the instances disclosed herein. By allowing only one master, a server is not inundated with requests from all receivers at once. The master status is then reassigned to another receiver when the master status receiver has obtained its desired software 808, ending the flow 810. The assignment can be to the next oldest client/receiver and/or done in any other structured manner. In some instances, it is not necessary to have masters and slaves because requests are unnecessary. This can occur when clients are satisfied by the multicasts without the need for the server to add additional software to the multicast list.

It should be noted that instances herein can also include information sent between entities. For example, in one instance, a data packet, transmitted between two or more devices, that facilitates content/services distribution is comprised of, at least in part, information relating to content/service distribution receiver software relayed to content/service distribution receivers via a multicast message.

It is to be appreciated that the systems and/or methods of the embodiments can be utilized in content and/or service distribution facilitating computer components and non-computer related components alike. Further, those skilled in the art will recognize that the systems and/or methods of the embodiments are employable in a vast array of electronic related technologies, including, but not limited to, computers, broadcast content/service receivers, and/or mobile devices, and the like.

What has been described above includes examples of the embodiments. It is, of course, not possible to describe every conceivable combination of components or methodologies for purposes of describing the embodiments, but one of ordinary skill in the art can recognize that many further combinations and permutations of the embodiments are possible. Accordingly, the subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system, comprising:
a multicast component that obtains multicast messages directed at receivers, the multicast message containing software for specific receivers; and
a software download component that automatically determines whether to extract the software based on the multicast message.

2. The system of claim 1, wherein the multicast component obtains the IP address for a receiver, dynamically, over an Internet Protocol (IP) network.

3. The system of claim 1, wherein the multicast component uses a statically configured IP address for the receiver, as desired.

4. The system of claim 1, wherein the software download component automatically downloads the software into a receiver when extraction is desired.

5. The system of claim 4, wherein the software download component automatically reboots the receiver after the software is downloaded.

6. The system of claim 1 wherein the multicast component obtains the multicast message over an Internet Protocol (IP) based network.

7. The system of claim 1 wherein the multicast message is a session announcement protocol (SAP) announcement that contains software associated information.

8. The system of claim 1, wherein the software download component can generate requests for software download, if extraction is desired.

9. The system of claim 1 wherein the software download component determines software extraction based on manufacturer and model information contained in the multicast message.

10. The system of claim 1, wherein the multicast component listens to an appropriate multicast, if extraction is desired by the software download component.

11. The system of claim 1, wherein the software download component determines software extraction based on software version information.

12. The system of claim 1, wherein the software download component requests software blocks when assigned a master status.

13. The system of claim 12, wherein the software download component lets a server reassign the master status to another software download component after completion of its software downloading.

14. A method, comprising:
receiving a multicast message directed at receivers, the multicast message containing at least one of software information and software for specific receivers; and
automatically determining whether to extract the software based on the multicast message.

15. The method of claim 14 further comprising:
automatically generating server-requests for appropriate receiver-software when extraction is desired.

16. The method of claim 14 further comprising:
automatically downloading the software into a receiver when extraction is desired.

17. The method of claim 15 further comprising:
automatically rebooting the receiver after downloading the software.

18. The method of claim 14 further comprising:
receiving the multicast message over an Internet Protocol (IP) based network.

19. The method of claim 14 further comprising:
receiving a multicast message comprising a session announcement protocol (SAP) announcement that contains software associated information.

20. The method of claim 14 further comprising:
determining software extraction based on manufacturer and model information contained in the multicast message.

21. The method of claim 14 further comprising:
determining software extraction based on software version information.

22. The method of claim 14 further comprising:
assigning one receiver in a group of receivers a master status; and
requiring a receiver to have a master status before allowing it to request software blocks.

23. The method of claim 22 further comprising:
permitting a receiver component to allow a server to reassign the master status to another receiver when the master status receiver has obtained its software.

24. A method, comprising:
transmitting a multicast message directed at content/service distribution receivers, the multicast message containing software for specific receivers; and
altering the software in the multicast message when a request is received from a receiver.

25. The method of claim 24 further comprising:
transmitting a multicast message comprising a session announcement protocol (SAP) announcement that contains software associated information.

26. A system, comprising:
means for receiving a multicast message directed at content/service distribution receivers, the multicast message containing software at least one of information and software for specific receivers; and
means for automatically determining whether to extract the software based on the multicast message.

27. The system of claim 26 further comprising:
means for automatically requesting appropriate software to an appropriate download server.

28. The system of claim 26 further comprising:
means for automatically downloading extracted software into a receiver; and
means for automatically rebooting the receiver.

29. A data packet, transmitted between at least two devices, the data packet comprising, at least in part, information relating to software relayed to receivers via a multicast message.

30. A computer readable medium having stored thereon computer executable components of the system of claim 1.

31. A device employing the method of claim 14 comprising at least one selected from the group consisting of a computer, a receiver, and a mobile device.
